(19) United States
(12) Patent Application Publication
(10) Pub. No.: US 2008/0007541 A1
(43) Pub. Date: Jan. 10, 2008

(54) Optical touchpad system and waveguide for use therein

(75) Inventors: Jonas Ove Philip Eliasson, Valby (DK); Niels Agersnap Larsen, Kongens Lyngby (DK); Jens Bastue, Virum (DK); Jens Wagenblast Stubbe Ostergaard, Lejre (DK)

Correspondence Address: PILLSBURY WINTHROP SHAW PITTMAN, LLP, P.O. BOX 10500, MCLEAN, VA, 22102, US

(73) Assignee: O-PEN A/S, Copenhagen (DK)

(21) Appl. No.: 11/480,892

(22) Filed: Jul. 6, 2006

(51) Int. Cl. G06F 3/042

(52) U.S. Cl. 345/176

(57) ABSTRACT

An optical touchpad system that includes a waveguide having a plurality of waveguide layers. For example, the waveguide may include an intervening layer, a signal layer, and/or other layers. The intervening layer may be defined by a first surface, a second surface and a substantially transparent material having a first index of refraction disposed between the first and the second surface of the interface layer. The signal layer may be defined by a first surface, a second surface and a substantially transparent material having a second index of refraction that is greater than the first index of refraction.

### FIELD OF THE INVENTION

The invention relates to an optical touchpad system, with a multilayer waveguide that includes at least one total internal reflection mirror, for determining information relating to a position of an object with respect to an interface surface of the optical touchpad system.

### BACKGROUND OF THE INVENTION

Generally, touchpad systems are implemented for a variety of applications. Some of these applications include, computer interfaces, keypads, keyboards, and other applications. Various types of touch pads are known. Optical touch pads have certain advantages over some other types of touch pads at least for some applications. Various types of optical touchpad systems may be used in some or all of these applications. However, conventional optical touchpad systems may include various drawbacks. For example, conventional optical touchpad systems may be costly, imprecise, bulky, temperamental, fragile, energy inefficient, or may have other weaknesses and/or drawbacks. Further, conventional systems may only be able to detect position of an object (e.g., a fingertip, a palm, a stylus, etc.) when the object is engaged with the touchpad. This may limit the position-detection of optical touchpad systems to detecting the position of the object in the plane of the surface of the touchpad. These and other limitations of conventional touchpad systems may restrict the types of applications for which touchpad systems may be employed as human/machine interfaces. Various other drawbacks exist with known touchpads, including optical touchpads.

### SUMMARY

One aspect of the invention relates to an optical touchpad system including a waveguide having a plurality of waveguide layers. For example, the waveguide may include an intervening layer, a signal layer, and/or other layers. The intervening layer may be defined by a first surface, a second surface and a substantially transparent material having a first index of refraction disposed between the first and the second surface of the interface layer. The signal layer may be defined by a first surface, a second surface and a substantially transparent material having a second index of refraction that is greater than the first index of refraction.

The waveguide may provide an interface surface of the optical system that can be engaged by a user by use of an animate object (e.g., one or more fingers) or an inanimate object (e.g., a stylus, a tool, and/or other objects). The intervening layer may be disposed in the waveguide between the interface surface and the signal surface such that the second surface of the intervening layer and the first surface of the signal layer are directly adjacent. Due to the difference in indices of refraction between the intervening layer and the signal layer, the boundary between the intervening layer and the signal layer may form a total internal reflection mirror with a predetermined critical angle. The predetermined critical angle may be a function of the difference in refractive index between the intervening layer and the signal layer. The total internal reflection mirror may be formed such that if light (or other electromagnetic radiation) becomes incident on the boundary between the intervening layer and the signal layer from within the signal layer at an angle of incidence that is greater than the critical angle, the light may be reflected back into the signal layer. However, if light becomes incident on the boundary between the intervening layer and the signal layer from within the signal layer at an angle of incidence that is less than the critical angle, the light may pass through the total internal reflection mirror into the intervening layer.

The waveguide and or parts thereof may further include a plurality of microstructures disposed therein. The microstructures may be formed in the waveguide with one or more predetermined properties. The predetermined properties may include a cross-sectional shape, a density, a distribution pattern, an index of refraction, and/or other properties. In some instances, the index of refraction of the microstructures may be greater than the first index of refraction. In these instances, the index of refraction of the microstructures may be less than or equal to the second index of refraction. In one or more implementations, the microstructures may be disposed at the boundary between the signal layer and the intervening layer. The microstructures may be designed to out-couple and/or in-couple light with the signal layer. Out-coupling light to the signal layer may include leaking light out of the signal layer past the total internal reflection mirror and into the intervening layer. The leaked light may include light traveling toward the boundary between the signal layer and the intervening layer with an angle of incidence to the plane of the boundary that is greater than the critical angle of the total internal reflection mirror. In-coupling light may include refracting light passing from the intervening layer into the signal layer such that the in-coupled light becomes incident on the total internal reflection mirror at an angle of incidence greater than the critical angle and is totally internally reflected.

At least one of the layers (e.g. the signal layer) may be optically coupled to one or more electromagnetic radiation emitters to receive electromagnetic radiation (e.g., light) emitted therefrom. One or more of the layers (e.g., the signal layer) may be optically coupled to one or more detectors to guide light thereto at least in part by total internal reflection.

In operation, according to one embodiment, light received by the signal layer is normally trapped within the signal layer at least in part by total internal reflection at the total internal reflection mirror formed at the boundary between the signal layer and the intervening layer. At least a portion of this light becomes incident on the microstructures formed within the waveguide and is leaked out of the signal layer. Some or all of the leaked light propagates to the interface surface of the optical touchpad surface. At the interface surface, or in proximity therewith, a portion of the leaked light interacts with an object (e.g., becomes reflected, scattered, or otherwise interacts with the object). Some of the light interacted with by the object is returned to the waveguide and propagates toward and through the signal layer. The microstructures may alter the path of this light such that it becomes incident on the total internal reflection mirror at an angle of incidence greater than the critical angle and is totally internally reflected. Guided in part by this total internal reflection at the total internal reflection mirror, the light then becomes incident on a detector optically coupled to the signal layer. The detector generates one or more output signals based on the received light that enable information about the position of the object with respect to the interface surface of the optical touchpad system to be determined. For example, this information may include the position of the object in a plane substantially parrelel with the plane of the interface surface and/or the distance of the object from the interface surface.

This configuration of optical touchpad provides various advantages over known touchpads. For example, the optical touchpad that may be able to provide accurate, reliable information about the position of the object in three-dimensions. This may enhance the control provided by the touchpad system to the user as an electronic interface. The operation of the optical touchpad may further enable an enhanced frame rate, reduced optical noise in the optical signal(s) guided to the one or more sensors, augment the ruggedness of the optical touchpad, an enhanced form factor (e.g., thinner), and/or provide other advantages.

These and other objects, features, benefits, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an optical touchpad system, according to one or more embodiments of the invention.

FIG. 2 illustrates a cross-section of a microstructure disposed in a waveguide, in accordance with one or more embodiments of the invention.

FIG. 3 illustrates a cross-section of a microstructure disposed in a waveguide, according to one or more embodiments of the invention.

FIG. 4 illustrates a cross-section of a microstructure disposed in a waveguide, in accordance with one or more embodiments of the invention.

FIG. 5 illustrates a cross-section of a microstructure disposed in a waveguide, in accordance with one or more embodiments of the invention.

FIG. 6 illustrates a cross-section of a microstructure disposed in a waveguide, in accordance with one or more embodiments of the invention.

FIG. 7 illustrates an optical touchpad system, according to one or more embodiments of the invention.

FIG. 8 illustrates an optical touchpad system, according to one or more embodiments of the invention.

FIG. 9 illustrates an optical touchpad system, in accordance with one or more embodiments of the invention.

FIG. 10 illustrates an optical touchpad system, according to one or more embodiments of the invention.

### DETAILED DESCRIPTION.

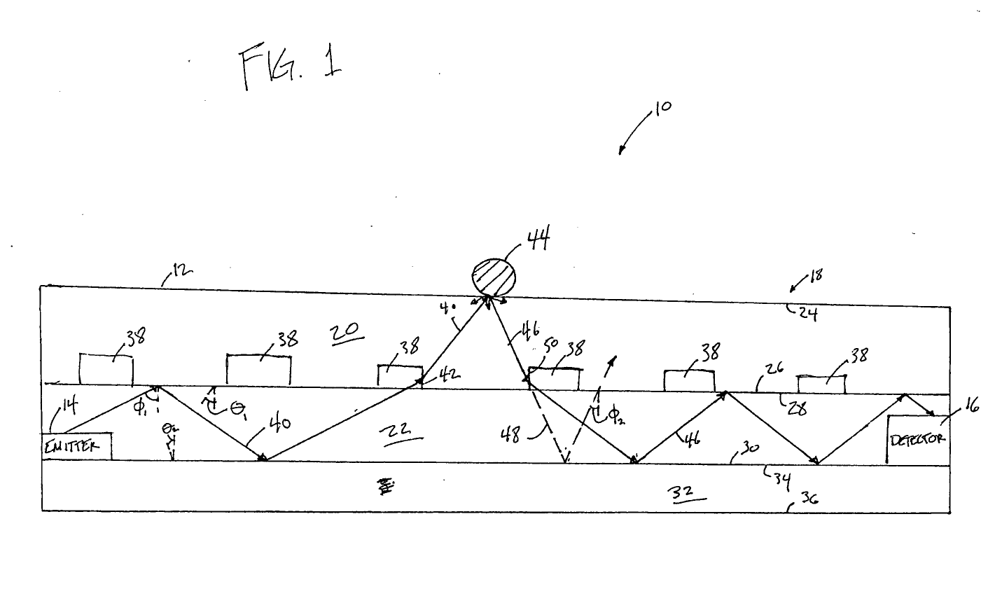

FIG. 1 illustrates an optical touchpad system 10 according to one or more embodiments of the invention. Optical touchpad system 10 may include an interface surface 12, one or more emitters 14, one or more detectors 16, and a waveguide 18. Interface surface 12 is configured such that a user can engage interface surface 12 with an object (e.g., a fingertip, a stylus, etc.). Optical touchpad system 10 detects information related to a position of the object with respect to the interface surface 12 (e.g., a distance between the object and interface surface 12, a position of the object in a plane substantially parallel with the plane of interface surface 12, etc.).

Emitters 14 emit electromagnetic radiation, and may be optically coupled with waveguide 18 so that electromagnetic radiation emitted by emitters 14 may be directed into waveguide 18. Emitters 14 may include one or more Organic Light Emitting Devices (“OLEDs”), lasers (e.g., diode lasers or other laser sources), LED, HCFL, CCFL, incandescent, halogen, ambient light and/or other electromagnetic radiation sources. In some embodiments, emitters 14 may be disposed at the periphery of waveguide 18 in optical touchpad system 10 (e.g., as illustrated in FIG. 1). However, this is not limiting and alternative configurations exist. For example, emitters 14 may be disposed away from waveguide 18 and electromagnetic radiation produced by emitters 14 may be guided to waveguide 18 by additional optical elements (e.g., one or more optical fibers, etc.). As another example, some or all of emitters 14 may be embedded within waveguide 18 beneath interface layer 12 at locations more central to optical touchpad system than those shown in FIG. 1. In some instances, emitters 14 may be configured to emit electromagnetic radiation over a predetermined solid angle. This predetermined solid angle may be determined to enhance signal detection, enhance efficiency, provide additional electromagnetic radiation for position detection, and/or according to other considerations.

Detectors 16 may monitor one or more properties of electromagnetic radiation. For instance, the one or more properties may include intensity, directionality, frequency, amplitude, amplitude modulation, and/or other properties. Detectors 16 may include one or more photosensitive sensors (e.g., one or more photosensitive diodes, CCD arrays, CMOS, arrays, line sensors etc.) that receive electromagnetic radiation, and may output one or more output signals that are indicative of one or more of the properties of the received electromagnetic radiation. In some implementations, detectors 16 may be optically coupled to waveguide 18 to receive electromagnetic radiation from waveguide 18, and may output one or more output signals that are indicative of one or more properties of the electromagnetic radiation received from waveguide 18. Based on these output signals, information about the position of the object with respect to interface surface 12 may be determined.

In some implementations, waveguide 18 may include a plurality of waveguide layers. For example, waveguide 18 may include an intervening layer 20, a signal layer 22, and/or other layers. Intervening layer 20 may be a generally planar layer bounded by a first surface 24 facing toward interface surface 12 and a second surface 26 on a side of intervening layer 20 opposite from first surface 24. Signal layer 22 may be a generally planar layer bounded by a first surface 28 facing toward interface surface 12 and a second surface 30 on a side of signal layer opposite from first surface 28.

As is shown in FIG. 1, intervening layer 20 may be disposed within waveguide 18 between interface surface 12 and signal layer 22 such that second surface 26 of intervening layer 20 abuts first surface 28 of signal layer 22. In some instances the abutment between surfaces 26 and 28 may be direct. In the implementations illustrated in FIG. 1, first surface 24 of intervening layer 20 forms interface surface 12. However, this is not intended to be limiting and in some implementations one or more additional layers of waveguide 18, such as one or more boundary layers and/or other auxiliary layers, may be disposed between intervening layer 20 and interface surface 12.

In some instances, intervening layer 20 is formed of a material (or materials) having a first index of refraction and signal layer 22 is formed of a material (or materials) having a second index of refraction. The second index of refraction is greater than the first index of refraction such that the boundary between intervening layer 20 and signal layer 22 may form a first total internal reflection mirror (“the first TIR mirror”) with a predetermined critical angle (illustrated in FIG. 1 as critical angle θ₁. As is discussed further below, the first TIR mirror may totally internally reflect electromagnetic radiation that becomes incident on the first TIR mirror from within signal layer 22 at an angle of incidence that is greater than critical angle θ₁.

Signal layer 22 may be bounded on second side 30 by a base layer 32. Base layer 32 may be defined by a first surface 34 and a second surface 36. In some implementations, such as the implementations illustrated in FIG. 1, base layer 32 may be included as a layer in waveguide 18. In these implementations, second surface 36 may comprise a mounting surface configured to be mounted to a base object. The base object may include virtually any object on which touchpad system 10 may be used as a touchpad. For example, the base object may include an electronic display (e.g., a display monitor, a mobile device, a television, etc.), a keypad, a keyboard, a button, an appliance (e.g., a stove, an air conditioner unit, a washing machine, etc.), a control panel (e.g., an automobile control panel, an airplane control panel, etc.), or other base objects.

In other implementations, base layer 32 may not be included as a layer in waveguide 18. In these implementations, base layer 32 may be formed as an integral part of the base object on which waveguide 18 is disposed. For instance, base layer 32 may include a glass (or other suitable material) layer that forms the screen of an electronic or other display. In other implementations (not shown), base layer 32 may be included in waveguide 18 as a composite layer formed from a plurality of sub-layers.

The boundary between base layer 32 and signal layer 22 may be formed such that a reflective surface is created that reflects magnetic radiation that becomes incident on the reflective surface from within signal layer 22 back into signal layer 22. For example, in some instances, base layer 32 may be formed from a material (or materials) with a third index of refraction that is less than the second index of refraction such that a second total internal reflection mirror (“the second TIR mirror”) may be formed at the interface of surfaces 30 and 36. The second TIR mirror may have a predetermined critical angle. Electromagnetic radiation incident on the second TIR mirror from within signal layer 22 at an angle of incidence greater than the critical angle of the second TIR mirror may be totally internally reflected back into signal layer 22.

In other instances, all or a portion of base layer 32 may be opaque. In these instances, the reflective surface formed between signal layer 22 and base layer 32 may reflect electromagnetic radiation by reflection other than total internal reflection. For example, the reflection may be a product of a reflective coating, film, or other layer disposed at these boundaries to reflect electromagnetic radiation back into signal layer 22.

According to various implementations, waveguide 18 may include a plurality of microstructures 38 distributed at the boundary between signal layer 22 and intervening layer 20. As will be described further hereafter, microstructures 38 may be formed to receive electromagnetic radiation from signal layer 22 that is traveling with an angle of incidence to the plane of the boundary between signal layer 22 and intervening layer 20 greater than critical angle θ₁ of the first TIR mirror, and to leak at least a portion of the received electromagnetic radiation from signal layer 22 into intervening layer 20. Microstructures 38 may have a fourth index of refraction.

In some instances, microstructures 38 may intrude from the boundary between intervening layer 20 and signal layer 22 into intervening layer 20. In these instances, the fourth index of refraction may be greater than the first index of refraction (index of refraction on intervening layer 20). The fourth index of refraction in these instances may further be less than or equal the second index of refraction (the index of refraction of signal layer 22). In various ones of these instances, microstructures 38 may be integrally with signal layer 22. As one alternative to this, microstructures may be formed separately from signal layer 22. Some of the shapes of microstructures 38, and some of the materials that may be used to form microstructures 38 are discussed further below.

In other instances (not shown), microstructures 38 may intrude into signal layer 22 from the boundary between signal layer 22 and intervening layer 20. In these instances, the fourth index of refraction may be less than the second index of refraction, and the fourth index of refraction may be less than or equal to the first index of refraction. In various ones of these instances, microstructures 38 may be integrally formed with intervening layer 20. In other ones of these instances, microstructures 38 may be formed separately from intervening layer 20.

As is illustrated in FIG. 1, emitter 14 may emit electromagnetic radiation (illustrated in FIG. 1 as electromagnetic radiation 40) into signal layer 22 that becomes incident on the first TIR mirror formed between intervening layer 20 and signal layer 22 at an angle of incidence (illustrated in FIG. 1 as φ₁) that is greater than the critical angle θ₁. Accordingly, electromagnetic radiation 40 may be totally internally reflected back into signal layer 22 by the first TIR mirror. As can further be seen in FIG. 1, electromagnetic radiation 40 may become incident on one of microstructures 38 such that electromagnetic radiation 40 is leaked past the first TIR mirror and into intervening layer 20.

As was mentioned above, microstructures 38 are formed with a fourth index of refraction that is greater than the first index of refraction of signal layer 20, and therefore may accept electromagnetic radiation that would be totally internally reflected at the boundary between signal layer 22 and intervening layer 20. Microstructures 38 are also shaped to provide surfaces, such as a surface 42 in FIG. 1, at angles that enable electromagnetic radiation that might otherwise be reflected by the first TIR mirror (e.g., electromagnetic radiation 40) to avoid total internal reflection, and instead be leaked from microstructures 38 into intervening layer 20.

Electromagnetic radiation 40 leaked into intervening layer 20 by microstructures 38 may propagate to, and in some cases through, interface surface 12. At interface surface 12, or at some position above interface surface 12, electromagnetic radiation 40 may become incident on an object 44. Object 44 may include an animate object (e.g., a fingertip, a palm etc.) or an inanimate object (e.g., a stylus, etc.) being positioned by a user with respect to interface surface 12. As electromagnetic radiation 40 becomes incident on object 44, object 44 may interact with electromagnetic radiation 40 (e.g., reflect, scatter, etc.) to return at least a portion of the electromagnetic radiation incident thereon (illustrated in FIG. 1 as electromagnetic radiation 46) back into waveguide 18.

As electromagnetic radiation 46 reenters waveguide 18, it may be directed into signal layer 22 by one of microstructures 38 such that electromagnetic radiation 46 may be guided within signal layer 22 to detector 16. It should be appreciated that without the presence of microstructures 38, electromagnetic radiation 46 would likely propagate along an optical path 48 that would not enable electromagnetic radiation 46 to be guided within signal layer 22 to detector 16 at least because the angle of incidence (illustrated in FIG. 1 as angle of incidence φ₂) of optical path 48 with respect to the first TIR mirror (assuming reflection at the boundary between signal layer 22 and base layer 32) would be less than the critical angle θ₁. However, microstructures 38 provide surfaces, such as surface 50, where the difference in refractive index between microstructure 38 and intervening layer 20 bend the path of electromagnetic radiation (e.g., electromagnetic radiation 46) such that electromagnetic radiation 46 may be totally internally reflected by the first TIR mirror when it next becomes incident on the boundary between signal layer 22 and intervening layer 20.

In response to electromagnetic radiation 46 becoming incident on detector 16, detector 16 may output one or more output signals that are related to one or more properties of electromagnetic radiation 46. For example, as was discussed above, the one or more properties may include intensity, directionality, frequency, amplitude, amplitude modulation, and/or other properties. From the one or more output signals, information related to the position of object 44 with respect to interface surface 12 (e.g., a distance from interface surface 12, a position on the plane of interface surface 12, etc.).

One of the purposes of microstructures 38 may include leaking a predetermined relative amount of electromagnetic radiation into and/or out of signal layer 22 (e.g., “in-coupling” and “out-coupling” electromagnetic radiation to signal layer 22) without substantially degrading the view of the base object (and/or base layer 32) through waveguide 18. For example, microstructures 38 may be designed and formed within waveguide 18 to in-couple and out-couple appropriate levels of electromagnetic radiation with minimal diffusion and/or radiation blockage of electromagnetic radiation emanating through waveguide 18 to and/or from the base object.

Although signal layer 22 is illustrated in FIG. 1 as including a single layer that is coupled to both emitters 14 and detectors 16, this implementation is illustrative only and other configurations of signal layer 22 may be employed without departing from the scope of this disclosure. For instance, in another implementation, signal layer 22 may include a first sub-layer and a second sub-layer. A boundary between the first sub-layer and the second sub-layer may form a total internal reflection mirror that totally internally reflects electromagnetic radiation incident thereon from within the first sub-layer at an angle of incidence that is greater than the critical angle of the total internal reflection mirror. The first sub-layer may be coupled to emitters 14 and the second sub-layer may be coupled to detectors 16. In this implementation, microstructures 38 may be disposed within waveguide 18 to out-couple electromagnetic radiation within the first sub-layer that has been received from emitters 14 such that the out-coupled electromagnetic radiation passes out of signal layer 22 and propagates toward interface surface 12 (e.g., such as electromagnetic radiation 40 in FIG. 1). Microstructures 38 may further be formed within waveguide 18 to in-couple electromagnetic radiation that has been directed toward signal layer 22 by an object at or near interface surface 12 (e.g., electromagnetic radiation 48 in FIG. 1) to signal layer 22. This in-coupled electromagnetic radiation may be guided to detectors 16 by the second sub-layer. Separating signal layer 22 into two sub-layers in this manner may decrease an amount of noise in optical system 10, and/or provide other benefits.

Various aspects of microstructures 38 may be varied to provide this and other functionality. For instance, the relative size and/or shape of microstructures 38 in the plane of the boundary between intervening layer 20 and signal layer 22 may be varied. Shapes with distinct edges and/or corners may result in “sparkling” or other optical artifacts that may become observable to users when viewing the base object (and/or base layer 32) through waveguide 18. Therefore, in some implementations, microstructures 38 may be round, or oval shaped, and/or have chamfered edges. As another example, the density of microstructures 38 may be controlled. As yet another example, the material(s) used to form microstructures 38 may be determined to enhance the processing of electromagnetic radiation as described above.

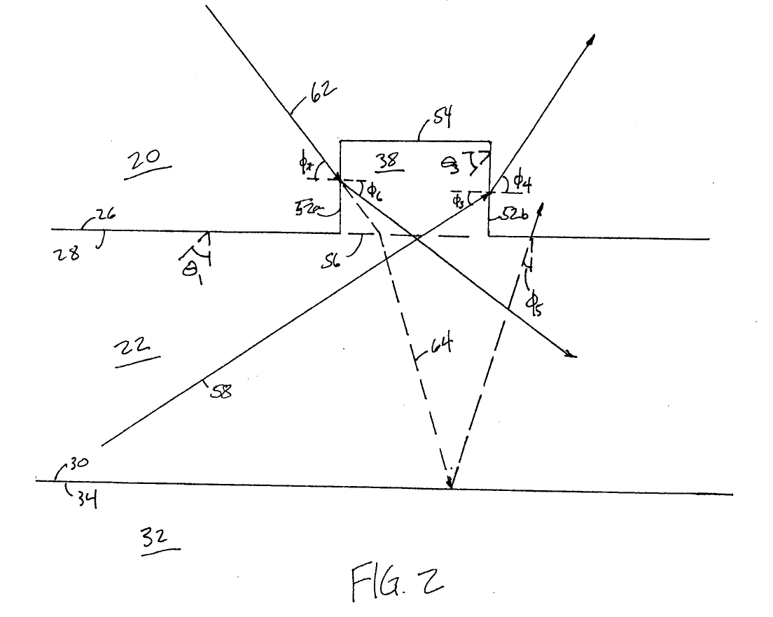

Another example of a property of microstructures 38 that may be varied to affect the amount of electromagnetic radiation that is out-coupled and/or in-coupled to signal layer 22 may include, the cross-sectional size and/or shape of microstructures 38. For instance, FIG. 2 illustrates a microstructure 38 with a pair of sidewalls 52a and 52b, a platform 54, and a base 56. It should be appreciated that in instances in which microstructures 38 are formed integrally with signal layer 22, base 56 may not comprise a physical boundary. In the implementation illustrated in FIG. 2, sidewalls 52a and 52b are oriented substantially perpendicular to the plane of the boundary between intervening layer 20 and signal layer 22.

FIG. 2 further illustrates a ray of electromagnetic radiation 58 that approaches the boundary between intervening layer 20 and signal layer 22 at an angle of incidence to this boundary that is greater than the critical angle θ₁ of the first TIR mirror (formed at the boundary between intervening layer 20 and signal layer 22). Thus, if microstructure 38 were not present, electromagnetic radiation 58 would follow a path 60, and be totally internally reflected back toward the boundary between signal layer 22 and base layer 32. However, in FIG. 2, electromagnetic radiation 58 is accepted into microstructure 38 and becomes incident on the surface provided the boundary between sidewall 52b and intervening layer 20. As was mentioned above, the index of refraction of microstructure 38 is greater than the index of refraction of intervening layer 20, so if electromagnetic radiation 58 is incident on sidewall 52b at an angle of incidence φ₃ that is greater than a critical angle θ₃ of the boundary between microstructure 38 and intervening layer 20 electromagnetic radiation 58 will be totally internally reflected by sidewall 52b. However, due to the orientation of sidewall 52b, the angle of incidence φ₃ is less than the critical angle θ₃. Thus, electromagnetic radiation 58 may be leaked out of microstructure 38 and into intervening layer 20.

As electromagnetic radiation 58 enters intervening layer 20 at sidewall 52b, the differences in refractive index between microstructure 38 and signal layer 22 bend the path of electromagnetic radiation 58 so that electromagnetic radiation 58 propagates away from sidewall 52b at an angle of refraction φ₄ that is greater than the angle of incidence φ₃. From sidewall 52b, electromagnetic radiation 58 proceeds through waveguide 18 toward interface surface 12, as was described above with respect to electromagnetic radiation 40 in FIG. 1.

FIG. 2 further illustrates a ray of electromagnetic radiation 62 traveling from interface surface 12 through waveguide 18 toward base layer 32. For example, electromagnetic radiation 62 may have been reflected, scattered, and/or otherwise interacted with by an object (e.g., object 44 in FIG. 1). Electromagnetic radiation 62 may be in-coupled to signal layer 22 by microstructure 38. For example, if microstructure 38 were not present, electromagnetic radiation 62 would likely pass through signal layer 22 without being guided by total internal reflection at the first TIR mirror between signal layer 22 and intervening layer 20. For instance, even if electromagnetic radiation 62 were reflected at the boundary between signal layer 22 and base layer 32, electromagnetic radiation 62 would likely follow a path similar to path 64 illustrated in FIG. 2 and become incident on the first TIR mirror at an angle of incidence φ₅ greater than the critical angle θ₁ and would probably pass through the first TIR mirror without being totally internally reflected.

However, as is illustrated in FIG. 2, microstructure 38 may bend the path of electromagnetic radiation 62 so that electromagnetic radiation enters signal layer 22 at an angle that will enable electromagnetic radiation to be totally internally reflected by the first TIR mirror. Due to the orientation of sidewall 52a, sidewall 52a may provide an interface between microstructure 38 and intervening layer 20 such that electromagnetic radiation 62 may enter microstructure 38 at sidewall 52a at an angle of refraction φ₆ that is less than an angle of incidence φ₇ of electromagnetic radiation 62 on the boundary between microstructure 38 and signal layer 22 at sidewall 52a. As a result of this refraction, the path of electromagnetic radiation 62 within signal layer 22 may be shallow enough to enable electromagnetic radiation 62 to be totally internally reflected by the first TIR mirror, and thereby guided to a detector (e.g., detector 16 in FIG. 1).

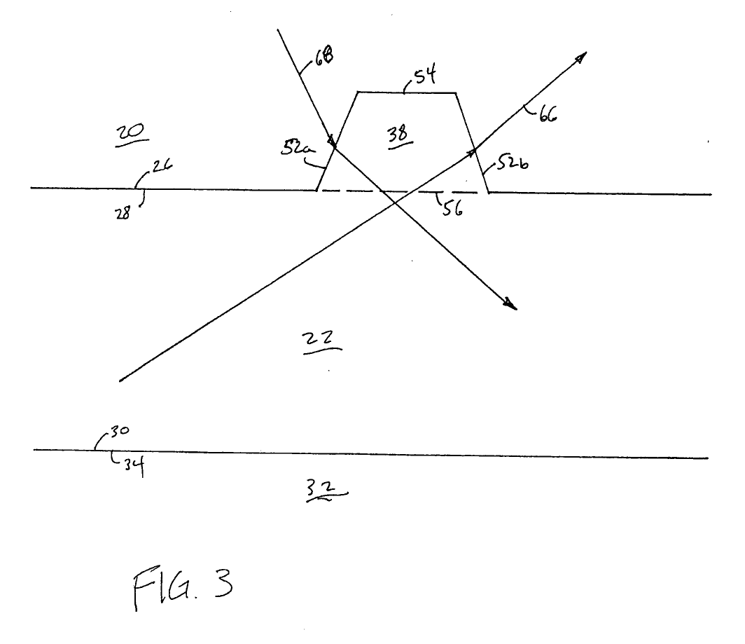

FIG. 3 illustrates another possible cross-section of microstructure 38 in which platform 54 may be shorter than base 56 such that sidewalls 52a and 52b taper outward from platform 54 to base 56. FIG. 3 further illustrates a ray of electromagnetic radiation 66 being out-coupled from signal layer 22 by microstructure 38, and a ray of electromagnetic radiation 68 being in-coupled to signal layer by microstructure 38 in substantially the same manner that electromagnetic radiation 58 was out-coupled to signal layer 22 and electromagnetic radiation 62 was in-coupled to signal layer 22 in FIG. 2 (e.g., as described above). Providing sidewalls 52a and 52b at angles similar to those illustrated in FIG. 3, may increase the relative amount of electromagnetic radiation in-coupled and out-coupled with signal layer 22. The amount of electromagnetic radiation that is in-coupled and out-coupled may increase because as the angle of sidewalls 52a and 52b is tilted in the manner illustrated in FIG. 3, the amount of surface provided by sidewalls 52a and 52b that serve to out-couple and in-couple electromagnetic radiation with signal layer 22 increases without increasing the overall distance between platform 54 and base 56.

In some designs, the increase in the range of angles of incidence to the general plane of the boundary between signal layer 22 and intervening layer 20 for which microstructure 38 will serve to in-couple and/or out-couple electromagnetic radiation with signal layer 22 provided by the implementation of FIG. 3 may be offset by changing one or more other properties of microstructure 38. For example, in implementations in which sidewalls 52a and 52b are angled in the manner illustrated in FIG. 3, the difference between the refractive indices of materials used to form signal layer 22 (and/or microstructures 38) and intervening layer 20 may be decreased in configurations like the one illustrated in FIG. 3. This may reduce a cost of the materials used to form signal layer 22 and or intervening layer 20. As another example, a size and/or a density of microstructures 38 disposed within waveguide 18 may be reduced.

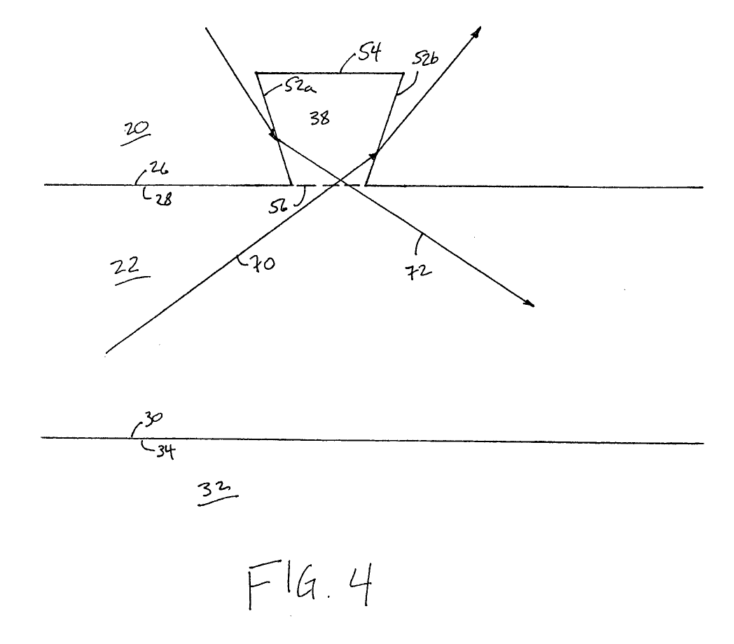

FIG. 4 illustrates yet another possible cross-section of microstructure 38 in which platform 54 may be longer than base 56 such that sidewalls 52a and 52b taper inward from platform 54 to base 56. FIG. 4 further illustrates a ray of electromagnetic radiation 70 being out-coupled from signal layer 22 by microstructure 38, and a ray of electromagnetic radiation 68 being in-coupled to signal layer by microstructure 38 in substantially the same manner that electromagnetic radiation 58 was out-coupled to signal layer 22 and electromagnetic radiation 62 was in-coupled to signal layer 22 in FIG. 2 (e.g., as described above). Providing sidewalls 52a and 52b at angles similar to those illustrated in FIG. 4, may reduce the relative amount of electromagnetic radiation in-coupled and out-coupled with signal layer 22.

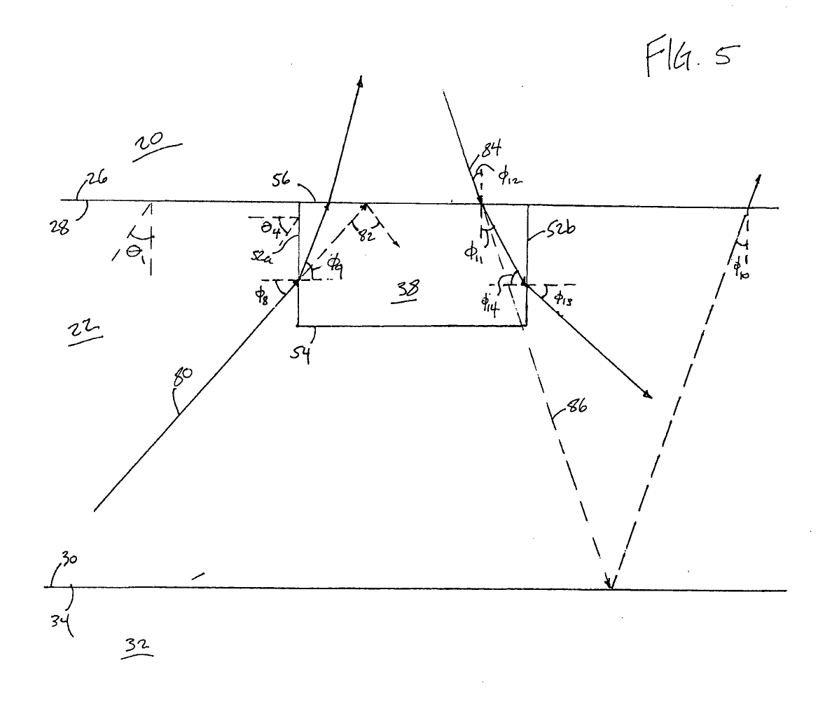

FIG. 5 illustrates one alternative implementation of microstructures 38 to the implementations illustrated in FIGS. 1-4. As is shown in FIG. 5, microstructures 38 may be formed at the boundary between signal layer 22 and intervening layer 20 to intrude into signal layer 22. As illustrated, the index of refraction of microstructure 38 may be less than the index of refraction of signal layer 22 or less than the indices of refraction of signal layer 22 and intervening layer 20. As was the case in FIGS. 2-4, microstructure 38 may be defined by a pair of sidewalls 52a and 52b, a platform 54, and a base 56. In the implementation illustrated in FIG. 5, sidewalls 52a and 52b are oriented substantially perpendicular to the plane of the boundary between intervening layer 20 and signal layer 22.

FIG. 5 further illustrates a ray of electromagnetic radiation 80 that approaches the boundary between intervening layer 20 and signal layer 22 at an angle of incidence to this boundary that is greater than the angle of incidence θ₁ of the first TIR mirror (formed at the boundary between intervening layer 20 and signal layer 22). Thus, if microstructure 38 were not present, electromagnetic radiation 80 would follow a path 82, and be totally internally reflected back toward the boundary between signal layer 22 and base layer 32. However, in FIG. 5, electromagnetic radiation 80 becomes incident on the surface provided the boundary between sidewall 52a and signal layer 22. As was mentioned above, the index of refraction of microstructure 38 is less than the index of refraction of signal layer 22, so if electromagnetic radiation 80 is incident on sidewall 52a at an angle of incidence φ₈ that is greater than a critical angle θ₄ of the boundary between microstructure 38 and signal layer 22 electromagnetic radiation 80 will be totally internally reflected by sidewall 52a. However, due to the orientation of sidewall 52a, the angle of incidence φ₈ is less than the critical angle θ₄. Thus, electromagnetic radiation 80 may be leaked out of signal layer 22 and into microstructure 38.

As electromagnetic radiation 80 enters microstructure 38 at sidewall 52a, the differences in refractive index between microstructure 38 and signal layer 22 bend the path of electromagnetic radiation 80 so that electromagnetic radiation 80 propagates away from sidewall 52a at an angle of refraction φ₉ that is greater than the angle of incidence φ₈. From microstructure 38, electromagnetic radiation 80 proceeds through waveguide 18 toward interface surface 12, as was described above with respect to electromagnetic radiation 40 in FIG. 1. In instances in which the refractive index of microstructure 38 is different from the refractive index of intervening layer 20, the path of electromagnetic radiation 80 may be bent again as it passes through base 56 and into intervening layer 20.

In some instances, microstructure 38 may be formed such that any electromagnetic radiation that is leaked from signal layer 22 at one of sidewalls 52a and 52b will exit microstructure 38 at base 56. In other words, the length of sidewalls 52a and 52b, the distance between sidewalls 52a and 52b, and/or the difference in the refractive indices of signal layer 22 and microstructure 38 may be designed to ensure that electromagnetic radiation that enters, for example, sidewall 52a, will travel within microstructure 38 at an angle so that the electromagnetic radiation will become incident on base 56 before crossing the length of microstructure 38 and becoming incident on sidewall 52b.

FIG. 5 further illustrates a ray of electromagnetic radiation 84 traveling from interface surface 12 through waveguide 18 toward base layer 32. For example, electromagnetic radiation 84 may have been reflected, scattered, and/or otherwise interacted with by an object (e.g., object 44 in FIG. 1). Electromagnetic radiation 84 may be in-coupled to signal layer 22 by microstructure 38. For example, if microstructure 38 were not present, electromagnetic radiation 84 would likely pass through signal layer 22 without being guided by total internal reflection at the first TIR mirror between signal layer 22 and intervening layer 20. For instance, even if electromagnetic radiation 84 were reflected at the boundary between signal layer 22 and base layer 32, electromagnetic radiation 62 would likely follow a path similar to path 86 illustrated in FIG. 2 and become incident on the first TIR mirror at an angle of incidence φ₁₀ greater than the critical angle θ₁ and would probably pass through the first TIR mirror without being totally internally reflected.

However, as is illustrated in FIG. 5, microstructure 38 may bend the path of electromagnetic radiation 84 so that electromagnetic radiation 84 enters signal layer 22 at an angle that will enable electromagnetic radiation to be totally internally reflected by the first TIR mirror. In instances in which microstructure 38 is formed from a material with a lower index of refraction than intervening layer 20, electromagnetic radiation 62 may leave base 56 of microstructure 38 at an angle of refraction φ₁₁ that is greater than an angle of incidence φ₁₂ of electromagnetic radiation 84 on the boundary between intervening layer 20 and microstructure 38 at base 56. Due to the orientation of sidewall 52b, sidewall 52b may provide an interface between microstructure 38 and signal layer 22 such that electromagnetic radiation 84 may leave sidewall 52b, of microstructure 38 at an angle of refraction φ₁₃ that is less than an angle of incidence φ₁₄ of electromagnetic radiation 84 on the boundary between microstructure 38 and signal layer 22 at sidewall 52b. As a result of this refraction, the path of electromagnetic radiation 62 within signal layer 22 may be shallow enough to enable electromagnetic radiation 84 to be totally internally reflected by the first TIR mirror, and thereby guided to a detector (e.g., detector 16 in FIG. 1).

It should be appreciated that in implementations similar to those illustrated in FIG. 5 in which microstructures 38 intrude into signal layer 22, the angles of sidewalls 52a and 52b may be varied to in-couple and/or out-couple more or less electromagnetic radiation (as was discussed above with respect to FIGS. 3 and 4). In these implementations, the distance between platform 54 and base 56 may be varied to control the amount of electromagnetic radiation that will be in-coupled and/or out-coupled with signal layer 22. For instance, in some of these implementations, platform 54 may be formed at first surface 24 of intervening layer 20.

In implementations such as the ones illustrated by FIG. 5, microstructures 38 may be formed integrally with, and/or from the same materials as (with the same index of refraction), intervening layer 20. Alternatively, in these implementations microstructures 38 may be formed separately from intervening layer 20 with different materials. For example, microstructures 38 may be formed of water, oil, gel (e.g., a low refractive sol-gel, etc.), a low refractive polymer, a gaseous substance, a mix of a gaseous substance and glass, and/or other materials. In some implementations, the boundaries of microstructures 38 may be coated with an anti-reflective coating. This may reduce distortion of images being projected by (or viewed on) the base object through waveguide 18. The anti-reflective coating may include, for example, nanostructures, quarter wavelength coating, or other anti-reflective coatings.

Although the configurations of microstructures illustrated in FIGS. 1-5 include microstructures that intrude into signal layer 22 and/or intervening layer 20 from the boundary between intervening layer 20 and signal layer 22, this is not intended to be limiting. In other implementations, for example, microstructures may be embedded wholly within signal layer 22 and may act as refractive elements to in-couple and out-couple electromagnetic radiation with signal layer 22. In these implementations, the index of refraction of the microstructures may be less than the index of refraction of signal layer 22 or less than the indices of refraction of signal layer 22 and intervening layer 20. For example, microstructures 38 may be formed of water, oil, gel (e.g., a low refractive sol-gel, etc.), a low refractive polymer, a gaseous substance (e.g., air, etc.), a mix of a gaseous substance and glass, and/or other materials. As one possible example, these refractive microstructures may be formed as air pockets within signal layer 22. In another example, the refractive microstructures may be formed as relatively low refractive structures that pass through signal layer 22 from first surface 28 to second surface 30 (e.g., holes through signal layer 22). Other configurations for microstructures that deflect and/or refract electromagnetic radiation to in-couple and/or out-couple the radiation with signal layer 22 are contemplated.

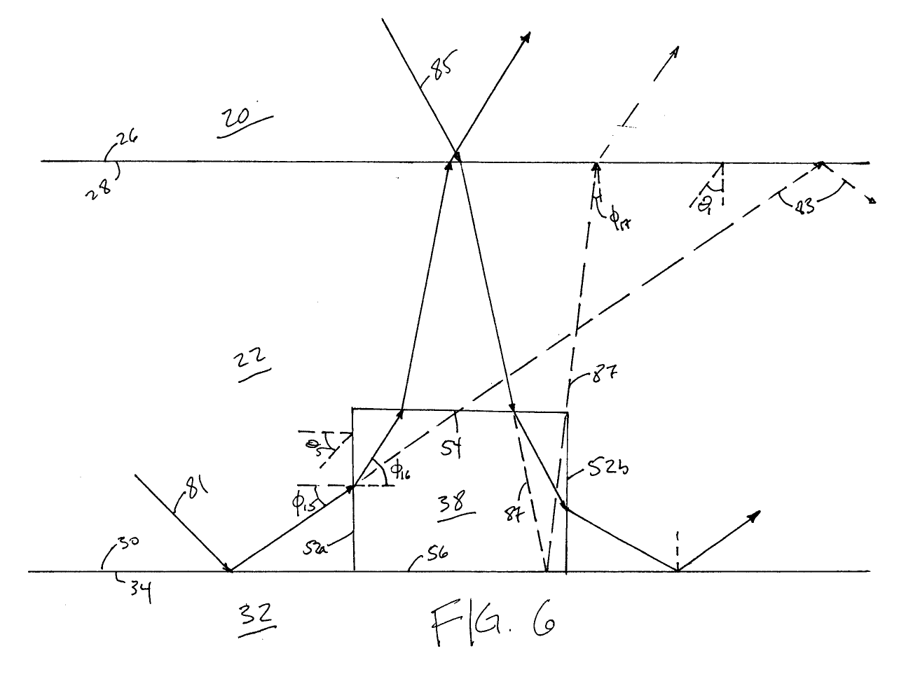

For example, FIG. 6 illustrates one alternative implementation of microstructures 38 to the implementations illustrated in FIGS. 1-5. As is shown in FIG. 6, microstructures 38 may be formed at the boundary between signal layer 22 and base layer 32 to intrude into signal layer 22. As illustrated, the index of refraction of microstructure 38 may be less than the index of refraction of signal layer 22 or less than the indices of refraction of signal layer 22 and base layer 32. As was the case in FIGS. 2-5, microstructure 38 may be defined by a pair of sidewalls 52a and 52b, a platform 54, and a base 56. In the implementation illustrated in FIG. 6, sidewalls 52a and 52b are oriented substantially perpendicular to the plane of the boundary between base layer 32 and signal layer 22.

FIG. 6 further illustrates a ray of electromagnetic radiation 81 traveling on an optical path such that electromagnetic radiation 81, in the absence of microstructure 38, would become incident on the boundary between intervening layer 20 and signal layer 22 at an angle of incidence to this boundary that is greater than the angle of incidence θ₁ of the first TIR mirror (formed at the boundary between intervening layer 20 and signal layer 22). Thus, if microstructure 38 were not present, electromagnetic radiation 81 would follow a path 83, and be totally internally reflected back toward the boundary between signal layer 22 and base layer 32. However, in FIG. 6, electromagnetic radiation 8 becomes incident on the surface provided by the boundary between sidewall 52a and signal layer 22. As was mentioned above, the index of refraction of microstructure 38 is less than the index of refraction of signal layer 22, so if electromagnetic radiation 81 is incident on sidewall 52a at an angle of incidence φ₁₅ that is greater than a critical angle θ₅ of the boundary between microstructure 38 and signal layer 22, electromagnetic radiation 81 will be totally internally reflected by sidewall 52a. However, due to the orientation of sidewall 52a, the angle of incidence φ₁₅ is less than the critical angle θ₅. Thus, electromagnetic radiation 81 may be leaked out of signal layer 22 and into microstructure 38.

As electromagnetic radiation 81 enters microstructure 38 at sidewall 52a, the differences in refractive index between microstructure 38 and signal layer 22 bend the path of electromagnetic radiation 81 so that electromagnetic radiation 81 propagates away from sidewall 52a at an angle of refraction φ₁₆ that is greater than the angle of incidence φ₁₅. From microstructure 38, electromagnetic radiation 81 proceeds through waveguide 18 toward interface surface 12.

FIG. 6 further illustrates a ray of electromagnetic radiation 85 traveling from interface surface 12 through waveguide 18 toward base layer 32. For example, electromagnetic radiation 85 may have been reflected, scattered, and/or otherwise interacted with by an object (e.g., object 44 in FIG. 1). Electromagnetic radiation 85 may be in-coupled to signal layer 22 by microstructure 38. For example, if microstructure 38 were not present, electromagnetic radiation 84 would likely pass through signal layer 22 without being guided by total internal reflection at the first TIR mirror between signal layer 22 and intervening layer 20. For instance, even if electromagnetic radiation 85 were reflected at the boundary between signal layer 22 and base layer 32, electromagnetic radiation 62 would likely follow a path similar to path 87 illustrated in FIG. 6 and become incident on the first TIR mirror at an angle of incidence φ₁₇ less than the critical angle θ₁ and would probably pass through the first TIR mirror without being totally internally reflected. However, as is illustrated in FIG. 6, microstructure 38 may bend the path of electromagnetic radiation 85 so that electromagnetic radiation 85 enters signal layer 22 from microstructure 38 at an angle that will enable electromagnetic radiation to be totally internally reflected by the first TIR mirror, and thereby guided to a detector (e.g., detector 16 in FIG. 1).

It should be appreciated that in implementations similar to those illustrated in FIG. 6 in which microstructures 38 intrude into signal layer 22 from base layer 32, the angles of sidewalls 52a and 52b may be varied to in-couple and/or out-couple more or less electromagnetic radiation (as was discussed above with respect to FIGS. 3 and 4). In these implementations, the distance between platform 54 and base 56 may be varied to control the amount of electromagnetic radiation that will be in-coupled and/or out-coupled with signal layer 22.

In implementations such as the ones illustrated by FIG. 6, microstructures 38 may be formed integrally with, and/or from the same materials as (with the same index of refraction), base layer 32. Alternatively, in these implementations microstructures 38 may be formed separately from base layer 32 with different materials. For example, microstructures 38 may be formed of water, oil, gel (e.g., a low refractive sol-gel, etc.), a low refractive polymer, a gaseous substance, a mix of a gaseous substance and glass, and/or other materials. In some implementations, the boundaries of microstructures 38 may be coated with an anti-reflective coating. This may reduce distortion of images being projected by (or viewed on) the base object through waveguide 18. The anti-reflective coating may include, for example, nanostructures, quarter wavelength coating, or other anti-reflective coatings.

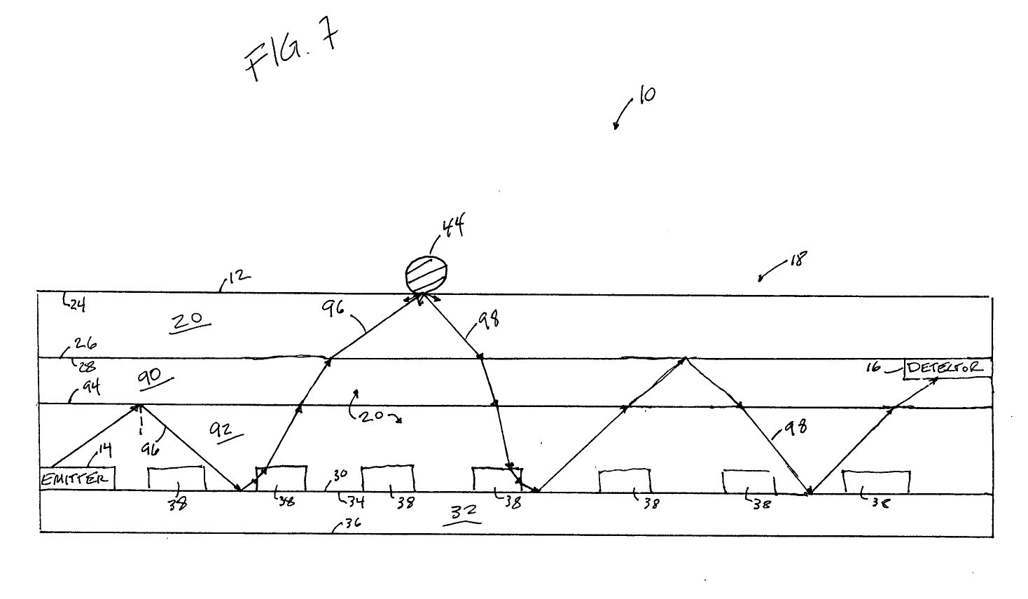

As was mentioned above, in some implementations, signal layer 22 may be separated into a plurality of sub-layers. In some instances, less than all of the sub-layers may include microstructures 38. For example, FIG. 7 illustrates optical touchpad system 10 including signal layer 20 made up of a first sub-layer 90 and a second sub-layer 92.

First sub-layer 90 may be bounded by first surface 28 of signal layer 22 and a sub-layer boundary 94. First sub-layer 90 may be formed from a material having a fifth index of refraction. The fifth index of refraction may be greater than the first index of refraction (the index of refraction of intervening layer 20) such that the first TIR mirror may be formed at the boundary between first sub-layer 90 and intervening layer 20. First sub-layer 90 may be optically coupled to detector 16.

Second sub-layer 92 may be bounded by sub-layer boundary 94 and second surface 30 of signal layer 22. Second sub-layer 92 may be formed from a material having a sixth index of refraction. The sixth index of refraction may be greater than the third index of refraction (the index of refraction of base layer 32) such that the second TIR mirror may be formed at the boundary of second sub-layer 92 and base layer 32. The sixth index of refraction may be greater than the fifth index of refraction such that a third total internal reflection mirror (“the third TIR mirror”) may be formed at sub-layer boundary 94. The third TIR mirror may totally internally reflect electromagnetic radiation incident sub-layer boundary 94 at an angle of incidence greater than a predetermined critical angle of the third TIR mirror. Second sub-layer 92 may be optically coupled to emitter 14.

Microstructures 38 may be formed at the boundary between second sub-layer 92 and base layer 32 to intrude into second sub-layer 92. Microstructures 38 may have an index of refraction less than the sixth index of refraction.

In the implementations illustrated in FIG. 7, emitter 14 may be configured to emit radiation only at angles that will become incident sub-layer boundary 94 at angles of incidence greater than the critical angle of the third TIR mirror. Thus, unless the emitted radiation is received by one of microstructures 38 intruding into second sub-layer 92, it may proceed through second sub-layer 92 without entering first sub-layer 90 and/or becoming incident on detector 16.

However, as is illustrated in FIG. 7, at least a portion of the electromagnetic radiation emitted by emitter 14 (illustrated as electromagnetic radiation 96) may be received by one of microstructures 38 and may be processed by microstructure 38 (e.g., as was described above with respect to FIG. 6) to become incident on sub-layer boundary 94 with an angle of incidence less than the critical angle of the third TIR mirror. Electromagnetic radiation 96 may therefore proceed past the third TIR mirror and propagate through waveguide 18 to become incident on object 44 at or near interface surface 12.

At least a portion of the electromagnetic radiation that is out-coupled from second sub-layer 92 by microstructures 38 that becomes incident on object 44 (e.g., electromagnetic radiation 96) may be reflected and/or scattered by object 44 in such a manner that it proceeds back into waveguide 18 (illustrated as electromagnetic radiation 98). Electromagnetic radiation 98 may travel through waveguide 18 and be received into one of microstructures 38.

As was discussed above with respect to FIG. 6, microstructure 38 may process electromagnetic radiation 98 such that it may become trapped within waveguide 18 by total internal reflection. For instance, referring again to FIG. 7, as electromagnetic radiation 98 exits microstructure 38, electromagnetic radiation 98 may travel at an angle with respect to sub-layer boundary 94 and/or the boundary between intervening layer 20 and first sub-layer 90 such that electromagnetic radiation passes through the third TIR mirror at sub-layer boundary 94, but is totally internally reflected by the first TIR mirror at the boundary between intervening layer 20 and first sub-layer 90. As can be seen in FIG. 7, this may result in electromagnetic radiation being guided by total internal reflection at the first TIR mirror and/or the second TIR mirror at the boundary between second sub-layer 92 and base layer 32 to become incident on detector 16. Thus, sub-layers 90 and 92 may be implemented to provide electromagnetic radiation that has been interacted with to detector 16 while at the same time keeping electromagnetic radiation emitted by emitter 14 from detector 16 until the emitted radiation has been out-coupled from and in-coupled to signal layer 20 (e.g., emitted radiation may not be able to pass “directly” from emitter 14 to detector 16 without first leaving signal layer 20). This may increase a signal to noise ratio in the electromagnetic radiation received by detector 16 and/or provide other enhancements.

In some implementations of the invention, one or more of the various layers and or structures of waveguide 18 may be formed by printing successive layers and structures on top of each other in sheets. This may enhance a form factor (e.g., thinness) of waveguide 18, a speed and/or cost efficiency of manufacture, and/or provide other enhancements to waveguide 18. In other implementations, conventional embossing and/or molding techniques may be used to create the layers and/or structures in waveguide 18. In implementations in which layers and/or structures within waveguide 18 are formed by printing, one or more of emitters 14, detectors 16, electronic circuitry, or other components of optical touchpad system 10 may be integrally formed with waveguide 18. For example, these components may be printed, laminated, or otherwise integrally formed within one or more of layers 20, 22, or 32 prior to, or concurrent with, the combination of layers 20, 22, and/or 32 in waveguide 18. This may reduce an overall cost of manufacturing optical touchpad system 10, enhance a robustness or ruggedness of optical touchpad system 10, increase an accuracy of alignment of the components in optical touchpad system 10, or provide other advantages. In some instances, one or more of emitters, 14, detectors 16, electronic circuitry, or other components may be formed integrally into one or more waveguide layers separate from waveguide 18, and then the one or more separate waveguide layers may be attached to waveguide 18 to optically couple the components formed on the separate waveguide layer(s) with signal layer 22.

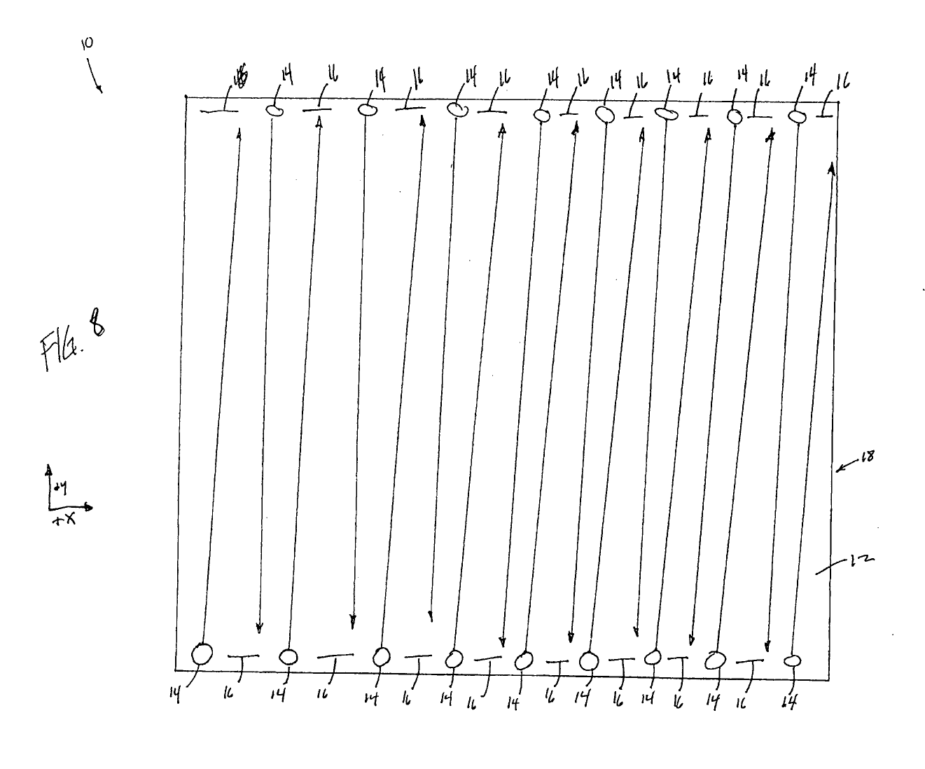

FIG. 8 illustrates a plan view of an optical touchpad system including interface surface 12 formed by waveguide 18, a plurality of emitters 14, and a plurality of detectors 16. In the implementation illustrated in FIG. 8, emitters 14 and detectors 16 may be disposed in alternating fashion along opposing sides of waveguide 18 and may be optically coupled to a signal layer within waveguide 18. Each of emitters 14 may be segmented to emit electromagnetic radiation in the general direction of a corresponding detector 16 positioned on the opposite side of waveguide 18. Each of detectors 16 may be similarly be segmented to receive electromagnetic radiation from its corresponding emitter 14. In some instances, emitters 14 may be positioned to emit electromagnetic radiation at a slight angle to the direction in which the corresponding detectors are configured to detect radiation. This may reduce the baseline amount of electromagnetic radiation received by detectors 16 when an object is not present, which may reduce the overall noise in system 10 without reducing signal strength when an object is reflecting and/or scattering radiation back into waveguide 18 toward detectors 16.

Other configurations implementing corresponding sets of emitters and detectors disposed on opposite sides of waveguide 18 that implement this offset irradiation are contemplated. For example, one side of waveguide 18 may include only emitters, while the opposite side may include only detectors for receiving radiation therefrom. In another example, arrays of emitters and detectors may be disposed on all four sides of waveguide 18, instead of only two as illustrated in FIG. 8.

In the implementation illustrated in FIG. 8, microstructures may be disposed within waveguide 18 to in-couple and out-couple electromagnetic radiation with a signal layer disposed in waveguide 18. For example, the microstructures may include structures and/or materials discussed above with respect to FIGS. 1-5. The microstructures may be distributed within waveguide 18 according to one or more predetermined distribution properties. The one or more predetermined distribution properties may include a density, a density function, with one or more predetermined microstructure shapes, and/or other properties.

In one implementation, the distribution of microstructures may include an array of microstructures disposed along each of the optical axes of the electromagnetic radiation emitted by emitters 14 in the configuration illustrated in FIG. 8 (or another “segmented” configuration of emitters and detectors). In some instances, the density of the microstructures in a given array may be designed to enable microstructures to out-couple a relatively uniform amount of the electromagnetic radiation regardless of the distance from the emitter 14 that corresponds to the array. For example, the density of the microstructures in the given array may increase as the distance from the corresponding emitter 14 increases. If no steps to ensure for uniform out-coupling are taken, the amount of electromagnetic radiation emanating out of waveguide 18 may dissipate as the distance from emitters 14 increases. This is at least in part because a relatively constant density of microstructures may out-couple a substantially constant relative amount of radiation regardless of the distance from an emitter. This causes the amount of electromagnetic radiation out-coupled from the signal layer to drop for distances further from the emitter as the overall amount of electromagnetic radiation from the emitter traveling within waveguide 18 drops (e.g., due to previous out-coupling).

Alternatives to varying the density of the microstructures in waveguide 18 along the optical axes of emitters 14 exits. For example, a size of the microstructures in the plane of interface surface 12 may be increased as the distance away from a give emitter increases along the corresponding axis. As another example, the cross-sectional size and/or shape of the microstructures may vary to provide the appropriate amount of out-coupling and in-coupling.

In some implementations, the density distribution may be designed to out-couple most or all of the electromagnetic radiation emitted by emitters 14 so that substantially all of the emitted electromagnetic radiation may be used to detect an object in the proximity of interface surface 12. This may enhance an overall optical efficiency of optical touchpad system 10 by reducing a required photon budget.

In some instances, the amount of noise caused by the microstructures in-coupling ambient radiation to the signal layer may be related to a ratio between the total area of the microstructures in the plane of interface surface 12 and the total area of interface surface 12. Accordingly, various properties of the microstructures may be designed to reduce the ratio of the total area of the microstructures in the plane of interface surface 12 to the total area of interface surface 12. In some implementations, this ratio may be below about 1/20. In one implementation, the ratio may be between about 1/50 and about 1/10,000. This ratio may be reduced by various mechanisms. For example, a density distribution, cross-sectional shapes and/or sizes, shapes in the plane of interface surface 12, differences in refractive index between the layers of waveguide 18 (e.g., due to materials used), and/or mechanisms that reduce the ratio of the microstructures in the plane of interface surface 12 to the total area of interface surface 12. Reducing this ratio may provide other enhancements to optical touchpad system 10, such as reducing a photon budget of optical system 10, enhancing an efficiency of optical system 10, and/or other enhancements.

In implementations using segmented emitter/detector groups, such as optical touchpad system 10 illustrated in FIG. 8, the amount of electromagnetic radiation that becomes incident on a given one of detectors 16 may increase when an object is brought in the proximity of interface surface 12. As was described above with respect to FIG. 1, this is due to the interaction of the object with electromagnetic radiation that has been emitted by the emitter 14 corresponding to the given detector and out-coupled from the signal layer, and the reflected and/or scattered electromagnetic radiation then being in-coupled back to the signal layer and guided to the give detector 16 at least in part by total internal reflection. Therefore, information related to the position of the object along one axis in the plane of interface surface 12 (illustrated in FIG. 8 as the x-axis) may be determined by monitoring the output signals generated by detectors 16 for increases in the amount of electromagnetic radiation received.

The amount of increase in electromagnetic radiation received by a given detector 16 as a result of electromagnetic radiation interacting with an object in the proximity of interface surface 12 may be an indicator of the position of the object along a second axis in the plane of interface surface 12 (illustrated in FIG. 8 as the y-axis), among other things. This is because as electromagnetic radiation that has been in-coupled to the signal layer is being guided towards the given detector 16, a portion of this electromagnetic radiation may again be out-coupled by the microstructures disposed in waveguide 18. As the distance that the in-coupled electromagnetic radiation must travel within the signal layer before reaching the given detector 16 increases the amount of the in-coupled electromagnetic radiation that will be out-coupled again increases, thereby reducing the amount of electromagnetic radiation that will be guided to detector 16 by the signal layer. This means that as the object is moved closer to the given detector 16 (along the y-axis), the amount of electromagnetic radiation reflected and/or scattered by the object that is received at the given detector 16 also increases. Therefore, by monitoring the amount of gain in electromagnetic radiation received by the given detector 16, the position of the object along the second axis in the plane of interface surface 12 may be determined.

As was discussed above, in other configurations optical touchpad system 10 may include arrays of emitters 14 and corresponding detectors 16 may also be included along the sides of waveguide 18 that are unoccupied in the configuration illustrated in FIG. 8. In these alternative configurations, the position of the object along the second axis in the plane of interface surface 12 may be determined by simply monitoring the output signals of this additional set(s) of detectors 16 for increases in received electromagnetic radiation.

As was mentioned above, the signal layer of waveguide 18 may be formed as a plurality from a plurality of sub-layers. For example, the signal layer may include a first sub-layer optically coupled with emitters 14 and a second sub-layer optically coupled with detectors 16, as was mentioned above. As another example, each of emitters 14 and detectors 16 may be coupled to a separate sub-layer formed within the signal layer. As yet another example, the signal layer may include a plurality of sub-layers with each sub-layer being optically coupled to a predetermined set of emitters 14 and/or detectors 16.

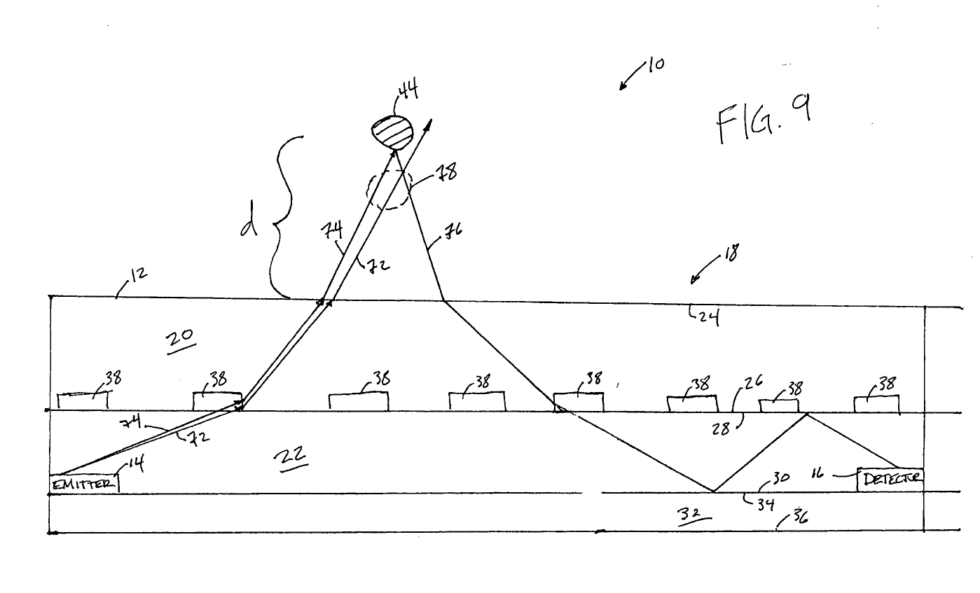

As has been previously mentioned, based on the output signals of detectors 16, a distance from interface surface 12 to an object may be determined. For example, FIG. 9 illustrates optical touchpad system 10 designed to determine a distance between interface surface 12 and object 44. As can be seen in FIG. 9, at least a portion of the electromagnetic radiation (illustrated in FIG. 9 as electromagnetic radiation 72 and 74) out-coupled from signal layer 22 by microstructures 38 may exit waveguide 18 through interface surface 18. At some distance d from interface surface 12, object 44 may interact with electromagnetic radiation 74 (e.g., scatter, reflect, etc.). At least a portion of the electromagnetic radiation (illustrated in FIG. 9 as electromagnetic radiation 76) interacted with by object 44 may be returned to waveguide 18 to be in-coupled back to signal layer 22 by microstructures 38. Electromagnetic radiation 76 may then be guided to detector 16 within signal layer 22 at least in part by total internal reflection at the first TIR mirror formed between signal layer 22 and intervening layer 20.

Based on the output signals generated by detector 16, the position of object 44 may be determined in at least one axis in the plane of interface surface 12 in the manner described above. The distance d may be determined based on the amount of in-coupled electromagnetic radiation (e.g., electromagnetic radiation 76) that has interacted with object 44 and eventually reaches detector 16. As distance d increases, the amount of in-coupled electromagnetic radiation from object 44 that reaches detector 16 decreases. The decrease in received electromagnetic radiation is due at least in part to the decreased amount of out-coupled electromagnetic radiation that reaches object 44 from signal layer 22 as distance d increases. For example, in FIG. 9, if object 44 were located at a position 78 closer to interface surface 12 than its actually position in FIG. 9 object 44 would interact with an increased amount of out-coupled electromagnetic radiation (electromagnetic radiation 74 and 76). This increase in electromagnetic radiation interacted with by object 44 would lead to more radiation being directed from object 44 to waveguide 18, which would in turn lead to more radiation being in-coupled by microstructures 38 to signal layer 22. Thus, by monitoring an amount of increase in the electromagnetic radiation received by detector 16, the distance d of object 44 from interface surface 12 may be determined.

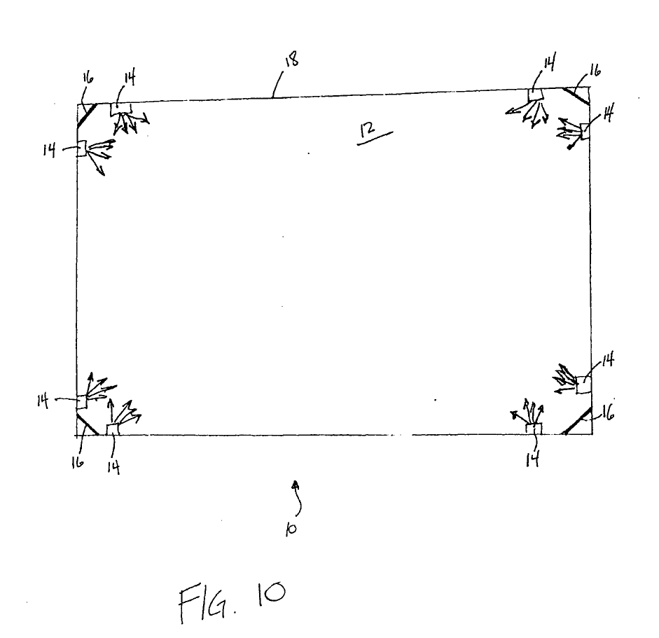

FIG. 10 illustrates a configuration of optical touchpad system 10, according to one or more implementations. In the implementations of FIG. 10, optical touchpad system 10 may include waveguide 18, emitters 14, and detectors 16. Emitters 14 shown in FIG. 10 may be provided at opposing positions at the periphery of waveguide 18 (e.g., at the corners) to emit electromagnetic radiation into waveguide 18. Emitters 14 may be adapted to provide radiation in a dispersive manner such that the combined emissions of emitters 14 may combine to create a substantially omni-directional field of electromagnetic radiation, with respect to directionality in the plane of interface surface 12. In some implementations, one or more optical elements may be formed within waveguide 18 to direct electromagnetic radiation emitted in one direction with respect the general plane of waveguide 18 into a plurality of directions with respect to the general plane of waveguide 18. This may enable electromagnetic radiation from emitters 14 to travel through waveguide 18 on an increased number of paths without increasing the number of emitters 14. The one or more optical elements may include refractive microstructures embedded within the signal layer, reflective structures (e.g., mirrors, half mirrors, etc.) embedded within the signal layer, diffractive structures embedded within the signal layer, and/or other optical elements.

Waveguide 18 may include a signal layer that is coupled to emitters 14 and detectors 16. Waveguide 18 may include a plurality of microstructures formed within waveguide 18 to out-couple and in-coupled electromagnetic radiation to the signal layer. In some implementations, waveguide 18 may operate in a manner similar to the implementations of waveguide 18 described above. This may include a signal layer that is formed as a single layer, or a signal layer that is formed as a plurality from a plurality of sub-layers. For example, the signal layer may include a first sub-layer optically coupled with emitters 14 and a second sub-layer optically coupled with detectors 16, as was mentioned above. As another example, each of emitters 14 and detectors 16 may be coupled to a separate sub-layer formed within the signal layer. As yet another example, the signal layer may include a plurality of sub-layers with each sub-layer being optically coupled to a predetermined set of emitters 14 and/or detectors 16.

Detectors 16 may be provided at opposing positions on the periphery of waveguide 18 (e.g., at the corners) to receive electromagnetic radiation from waveguide 18. Detectors 16 may generate output signals in response to the received electromagnetic radiation that enable information related to the position of an object with respect to interface surface 12 of optical touchpad system 10, and/or other information related to the object to be determined. In some instances, each detector 16 may enable a determination of a direction (in a plane substantially parallel to the plane of interface surface 12) from that detector 16 to the position of the object when the object is positioned at or near interface surface 12.

By aggregating the directional measurements of the position of the object enabled by detectors 16, the position of the object in a plane substantially parallel with the plane of interface surface 12 may be determined. In one implementation, the directional measurements of some or all of the possible pairings of detectors 16 may be used to determine a separate positional determination by triangulation, and then these positional determinations may be aggregated to provide a determination of the position of the object in a plane substantially parallel with the plane of interface surface 12. For example, referring to FIG. 10, the directional measurements of a first one of detectors 16 (illustrated as 16a) and a second one of detectors 16 (illustrated as 16b) may enable a first positional determination, detector 16b and a third one of detectors 16 (illustrated as 16c) may enable a second positional determination, detector 16c and a fourth one of detectors 16 (illustrated as 16d) may enable a third positional determination, detector 16b and detector 16c may enable a fourth positional determination, and so on. Then these separate positional determinations may be averaged to provide a final determination of the position of the object in a plane substantially parallel with the plane of interface surface 12. Aggregating the separate positional determinations may provide an enhanced accuracy by correcting for various forms of systematic noise. For example, as will be discussed further below, the movement of the object toward or away from interface surface 12 may shift the directional reading of some or all of detectors 16. However, by aggregating the separate positional determinations, inaccuracies due to these shifts may be reduced.

It should be appreciated that the configuration of emitters 14 and detectors 16 illustrated in FIG. 10 are not meant to be limiting, and that other implementations may include providing emitters 14 and detectors 16 at alternative locations with respect to waveguide 18. Further, the number of emitters 14 and detectors 16 are also illustrative, and other implementation may utilize more or less emitters 14 and/or detectors 16.

In some implementations of optical touchpad system 10, including the configuration described above with respect to FIG. 10, various mechanisms may be implemented to reduce noise in optical system 10 caused by ambient radiation. For example, wavelength-specific emitters and/or detectors may be used. As another example, emitters 14 may be pulsed. For instance, emitters 14 may include high intensity sources coupled with capacitors to output short, high intensity bursts. In some implementations, emitters 14 may be pulsed (or otherwise modulated) at different frequencies to reduce noise caused internally by the emitters. Controlling the wavelengths and/or the amplitude of emitters 14 may further enable discrimination between optical signals received by detectors 16 from separate ones of emitter 14 (or from groups of emitters with similar outputs). This discrimination may enable an enhanced accuracy in determining information related to the position of the object, and/or other information related to the object, based on the output signals generated by detectors 16.

In the configuration of optical touchpad system 10 illustrated in FIG. 10, the intensity of electromagnetic radiation that is received by detectors 16 may increase as the user moves the object toward interface surface 12 (as was discussed above with respect to FIG. 9). This may enable a determination of the distance d between the object and interface surface 12 for each of detectors 16 based on the output signals of detectors 16. The individual determinations of distance d may be aggregated to provide a final determination of the distance d. The determination of the distance d may enable the position of the object to be determined in three-dimensions with respect to interface surface 12.

In some implementations of optical touchpad system 10, including the configurations described above, various mechanisms may be implemented to reduce noise in optical system 10 caused by ambient radiation. For example, wavelength-specific emitters and/or detectors may be used. As another example, the emitters may be pulsed. For instance, the emitters may include high intensity sources coupled with capacitors to output short, high intensity bursts. In some implementations, the emitters may be pulsed (or otherwise modulated) at different frequency to reduce noise caused internally by the emitters.

According to various implementations, microstructures may be distributed within waveguide 18 to selectively out-couple electromagnetic radiation to and in-couple electromagnetic radiation from one or more predetermined areas on interface surface 12. In these implementations, the one or more predetermined areas may form interface areas where a user may provide input to optical touchpad system 10 by providing an object at or near interface surface 12 within one of the interface areas. However, if the user provides an object at or near interface surface 12 outside of the interface area(s) (e.g., at one of the areas that does not receive radiation from and/or provide radiation to signal layer 22 via the microstructures), optical system 10 may not receive input. This feature may be used to define buttons, keys, scroll pad areas, dials, and/or other input areas on interface surface 12.

As was mentioned above, in some instances waveguide 18 may be formed such that emitters 14 and/or detectors 16 may be disposed at waveguide 18 in locations somewhat removed from the interface areas formed on interface surface 12 of waveguide 18. These implementations may be employed in instances in which optical touchpad system 10 is provided as an interface in acrid and/or extreme temperature settings (e.g., as heavy machine interfaces, etc.). To accommodate these setting, waveguide 18 may provide the interface areas interface surface 12 in a location exposed to the hostile conditions, while one or both of emitters 14 and detectors may be disposed in locations that are somewhat removed to milder conditions.

According to one or more implementations, the disposal of microstructures within waveguide 18 in various configurations of optical touchpad system 10 (e.g., as illustrated in FIGS. 8 and/or 10) may enable the determination of other information related to an object located at or near interface surface 12. For instance, some of these additional determinations are disclosed in co-pending U.S. patent application Ser. No. Attorney Docket No. 507199-0353177, entitled “Optical touchpad with Three-Dimensional Position Determination,” and filed Jul. 6, 2006, which is incorporated herein by reference.

In some implementations, emitters 14 and/or detectors 16 may be operatively coupled to one or more processors. The processors may be operable to control the emission of electromagnetic radiation from emitters 14, receive and process the output signals generated by detectors (e.g., to calculate information related to the position of objects with respect to interface surface 12 as described above), or provide other processing functionality with respect to optical touchpad system 10. In some instances, the processors may include one or more processors external to optical touchpad system 10 (e.g., a host computer that communicates with optical touchpad system 10), one or more processors that are included integrally in optical touchpad system 10, or both.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An optical touchpad system comprising:
one or more emitters configured to emit electromagnetic radiation;
one or more sensors configured to receive electromagnetic radiation and output one or more output signals that correspond to one or more properties of the received electromagnetic radiation; and
a waveguide that guides a portion of the electromagnetic radiation emitted by the emitters to the sensors, the waveguide comprising:
an interface surface that is generally planar and forms a touchpad surface;
an intervening layer having a first index of refraction and being disposed within the waveguide;
a signal layer having a second index of refraction that is greater than the first index of refraction and being disposed within the waveguide abutting the intervening layer on a side of the intervening layer opposite from the outer surface,
wherein the abutment between the signal layer and the intervening layer forms a generally planar boundary therebetween, and
wherein the signal layer is optically coupled to (i) the one or more emitters to receive electromagnetic radiation emitted therefrom, and (ii) the one or more sensors such that the sensors receive electromagnetic radiation from the signal layer;
a total internal reflection mirror having a predetermined critical angle, the total internal reflection mirror being formed at the boundary between the signal layer and the intervening layer such that electromagnetic radiation that is incident on the total internal reflection mirror from within the signal layer is deflected back into the signal layer if the electromagnetic radiation becomes incident on the total internal reflection mirror at an angle of incidence greater than the critical angle;
a reflective surface formed on a side of the signal layer opposite from the boundary between the signal layer and the intervening layer, wherein the reflective surface reflects electromagnetic radiation that is incident on the reflective surface from within the signal layer back into the signal layer; and
a plurality of microstructures disposed within the waveguide, wherein the microstructures are formed (i) to receive electromagnetic radiation from the signal layer that is traveling with an angle of incidence to the plane of the boundary between the signal layer and the intervening layer that is greater than the critical angle of the total internal reflection mirror, and (ii) to leak at least a portion of the received electromagnetic radiation from the signal layer into the intervening layer.

2. The optical touchpad system of claim 1, wherein the microstructures are further formed (iii) to receive electromagnetic radiation that has been leaked from the signal layer by the microstructures and scattered and/or reflected by an object to travel back toward the boundary between the signal layer and the intervening layer at an angle of incidence to the plane of the boundary between the signal layer and the intervening layer that is less than the critical angle of the total internal reflection mirror, and (iv) to bend the path of at least a portion of the received electromagnetic radiation such that the at least a portion of the received electromagnetic radiation enters the signal layer with an angle of refraction to the plane of the boundary between the signal layer and the intervening layer that is greater than the critical angle of the total internal reflection mirror so that the electromagnetic radiation with the angle of refraction to the plane of the boundary between the signal layer and the intervening layer that is greater than the critical angle of the total internal reflection mirror is guided to the one or more sensors by the reflective surface and the total internal reflection mirror.

3. The optical touchpad system of claim 2, further comprising one or more processors that are operatively coupled with the one or more sensors to receive the output signals output by the/one or more sensors, the one or more processors being configured to determine information about the position of the object with respect to the outer surface based on the received output signals that correspond to one or more of the properties of electromagnetic radiation that is scattered and/or reflected by the object and guided to the one or more sensors by the total internal reflection mirror and/or the reflective surface.

4. The optical touchpad system of claim 1, wherein the reflective surface comprises a second total internal reflection mirror.

5. The optical touchpad system of claim 2, wherein the signal layer comprises a first sub-layer that is optically coupled to the one or more emitters and a second sub-layer that is optically coupled to the one or more detectors.

6. The optical touchpad system of claim 1, wherein the plurality of microstructures include one or more microstructures that intrude from the boundary between the intervening layer and the signal layer into the intervening layer.

7. The optical touchpad system of claim 1, wherein the plurality of microstructures include one or more microstructures that intrude from the boundary between the intervening layer and the signal layer into the signal layer.

8. The optical touchpad system of claim 1, wherein the plurality of microstructures include one or more microstructures that are embedded within the signal layer.

9. The optical touchpad system of claim 1, wherein the plurality of microstructures include one or more microstructures that extend from the boundary between the intervening layer and the signal layer to the reflective surface.

10. A waveguide configured to receive electromagnetic radiation from one or more emitters and guides a portion of the received electromagnetic radiation to one or more sensors, the waveguide comprising:
an outer surface that is generally planar and forms a touchpad surface;
an intervening layer having a first index of refraction and being disposed within the waveguide;
a signal layer having a second index of refraction that is greater than the first index of refraction and being disposed within the waveguide abutting the intervening layer on a side of the intervening layer opposite from the outer surface,
wherein the abutment between the signal layer and the intervening layer forms a generally planar boundary therebetween, and
wherein the signal layer is optically coupled to (i) the one or more emitters to receive electromagnetic radiation emitted therefrom, and (ii) the one or more sensors such that the sensors receive electromagnetic radiation from the signal layer;
a total internal reflection mirror having a predetermined critical angle, the total internal reflection mirror being formed at the boundary between the signal layer and the intervening layer such that electromagnetic radiation that is incident on the total internal reflection mirror from within the signal layer is deflected back into the signal layer if the electromagnetic radiation becomes incident on the total internal reflection mirror at an angle of incidence greater than the critical angle;
a reflective surface formed on a side of the signal layer opposite from the boundary between the signal layer and the intervening layer, wherein the reflective surface reflects electromagnetic radiation that is incident on the reflective surface from within the signal layer back into the signal layer; and
a plurality of microstructures disposed within the waveguide,
wherein microstructures are formed to receive electromagnetic radiation from the signal layer that is traveling with an angle of incidence to the plane of the boundary between the signal layer and the intervening layer greater than the critical angle of the total internal reflection mirror, and to leak at least a portion of the received electromagnetic radiation from the signal layer into the intervening layer.

11. The waveguide of claim 10, wherein the microstructures are further formed (iii) to receive electromagnetic radiation that has been leaked from the signal layer by the microstructures and scattered and/or reflected by an object to travel back toward the boundary between the signal layer and the intervening layer at an angle of incidence to the plane of the boundary between the signal layer and the intervening layer that is less than the critical angle of the total internal reflection mirror, and (iv) to bend the path of at least a portion of the received electromagnetic radiation such that the at least a portion of the received electromagnetic radiation enters the signal layer with an angle of refraction to the plane of the boundary between the signal layer and the intervening layer that is greater than the critical angle of the total internal reflection mirror so that the electromagnetic radiation with the angle of refraction to the plane of the boundary between the signal layer and the intervening layer that is greater than the critical angle of the total internal reflection mirror is guided to the one or more sensors by the reflective surface and the total internal reflection mirror.

12. The waveguide of claim 10, wherein the reflective surface comprises a second total internal reflection mirror.

13. The waveguide of claim 11, wherein the signal layer comprises a first sub-layer that is optically coupled to the one or more emitters and a second sub-layer that is optically coupled to the one or more detectors.

14. The waveguide of claim 10, wherein the plurality of microstructures include one or more microstructures that intrude from the boundary between the intervening layer and the signal layer into the intervening layer.

15. The waveguide of claim 10, wherein the plurality of microstructures include one or more microstructures that intrude from the boundary between the intervening layer and the signal layer into the signal layer.

16. The waveguide of claim 10, wherein the plurality of microstructures include one or more microstructures that are embedded within the signal layer.

17. The optical touchpad system of claim 10, wherein the plurality of microstructures include one or more microstructures that extend from the boundary between the intervening layer and the signal layer to the reflective surface.

18. An optical touchpad system comprising:
one or more emitters configured to emit electromagnetic radiation;
one or more sensors configured to receive electromagnetic radiation and output one or more output signals that correspond to one or more properties of the received electromagnetic radiation; and
a waveguide that guides a portion of the electromagnetic radiation emitted by the emitters to the sensors, the waveguide comprising:
an interface surface that is generally planar and forms a touchpad surface;
a signal layer that is optically coupled to (i) the one or more emitters to receive electromagnetic radiation emitted therefrom, and (ii) the one or more sensors such that the sensors receive electromagnetic radiation from the signal layer, the signal layer being formed to direct electromagnetic radiation that has been emitted by the one or more emitters to the one or more detectors at least in part by total internal reflecion; and
a plurality of microstructures disposed within the waveguide, wherein the microstructures are formed (i) to receive electromagnetic radiation emitted by the one or more emitters that is being directed toward the one or more detectors, (ii) to leak at least a portion of the received electromagnetic radiation from the signal layer out of the signal layer and toward the interface surface, (iii) to receive electromagnetic radiation that has been leaked from the signal layer by the microstructures and scattered and/or reflected by an object to travel back toward the signal layer, and (iv) to bend the path of at least a portion of the received electromagnetic radiation such that the at least a portion of the received electromagnetic radiation is directed by the signal layer to the one or more detectors.

19. The optical touchpad system of claim 18, wherein the plurality of microstructures are disposed within the waveguide such that the electromagnetic radiation the is received by the microstructures from the signal layer is leaked to the interface surface only at one or more predetermined interface areas on the interface surface.

20. The optical touchpad system of claim 16, wherein the plurality of microstructures are formed such that the ratio of the total area of the microstructures in the plane of the interface surface to the total area of the interface surface is less than 1/20.
